(19) United States
(12) Patent Application Publication
(10) Pub. No.: US 2003/0084664 A1
(43) Pub. Date: May 8, 2003

(54) Hydraulic transmission device

(76) Inventor: Chien-Chin Yeh, Kaoshiung City (TW)

Correspondence Address: OSTROLENK FABER GERB & SOFFEN, 1180 AVENUE OF THE AMERICAS, NEW YORK, NY, 100368403

(21) Appl. No.: 10/005,941

(22) Filed: Nov. 8, 2001

(51) Int. Cl. B60T 11/26

(52) U.S. Cl. 60/585

(57) ABSTRACT

A hydraulic transmission device includes a front end member and a rear end member between which an active device, an active rotor, an intermediate member, a passive rotor and a passive device are connected. A closed space is defined in the transmission device and each part of the device has paths, openings or recesses which form a path system for the hydraulic liquid. The active device has control valves which closes or opens the paths so as to rotate the active rotor which is connected to an input power, and drive the passive rotor which is connected to an output device. The pressure of the hydraulic liquid can be controlled to rotate the passive rotor in desired ways.

### FIELD OF THE INVENTION

The present invention relates to a hydraulic transmission device that includes several rotors which are in communication with each other via various passages and holes. The device controls the volume and paths that the hydraulic liquid goes to obtain different output.

### BACKGROUND OF THE INVENTION

A conventional transmission device for vehicles has a complex structure and a huge number of parts so that it occupies a large space. Most of the parts of the conventional transmission device for vehicles are made of metal so that it is heavy. These inherent problems result in an inefficient operation and the conventional transmission device is difficult to be manufactured and assembled. Although electric motor used in vehicles is developed in the past few years, it cannot achieve a satisfied result when compared with the gas-combustion engine.

### SUMMARY OF THE INVENTION

The primary object of the present invention is to provide a transmission device that uses a path mechanism that can control the volume of the hydraulic liquid passing through specific paths so as to transfer a fixed input speed or torque into desired output speed or torque.

The transmission device includes two end members with an active device, an active rotor, an intermediate member, a passive rotor and a passive device connected therebetween so as to form a closed space. A plurality of paths and holes are defined through these parts so as to allow the hydraulic liquid to flow therethrough.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the transmission device of the present invention;

FIG. 2 is a front view, a top view and a side view of the front end member of the transmission device of the present invention;

FIG. 3 is a front view, a top view and a side view of the rear end member of the transmission device of the present invention;

FIG. 4 is a front view, a top view and a side view of the active device of the transmission device of the present invention;

FIG. 5A is a side view to show the control valve of the transmission device of the present invention;

FIG. 5B is a side view to show the reverse-flow control valve of the transmission device of the present invention;

FIG. 6 shows the cross section of the composition of the chamber in the transmission device of the present invention;

FIG. 7 is a front view, a top view and a side view of the passive device of the transmission device of the present invention;

FIG. 8 is an exploded view to show the active rotor and the passive rotor of the transmission device of the present invention;

FIG. 9 is a front view, a top view and a side view of the intermediate member of the transmission device of the present invention;

FIG. 10 shows that the control valves and the directions of the hydraulic liquid when idling;

FIG. 11 shows that the control valves and the directions of the hydraulic liquid when in first gear status, and

FIG. 12 shows that the control valves and the directions of the hydraulic liquid when in backward gear status.

### DETAILED DESCRIPTION OF THE INVENTION

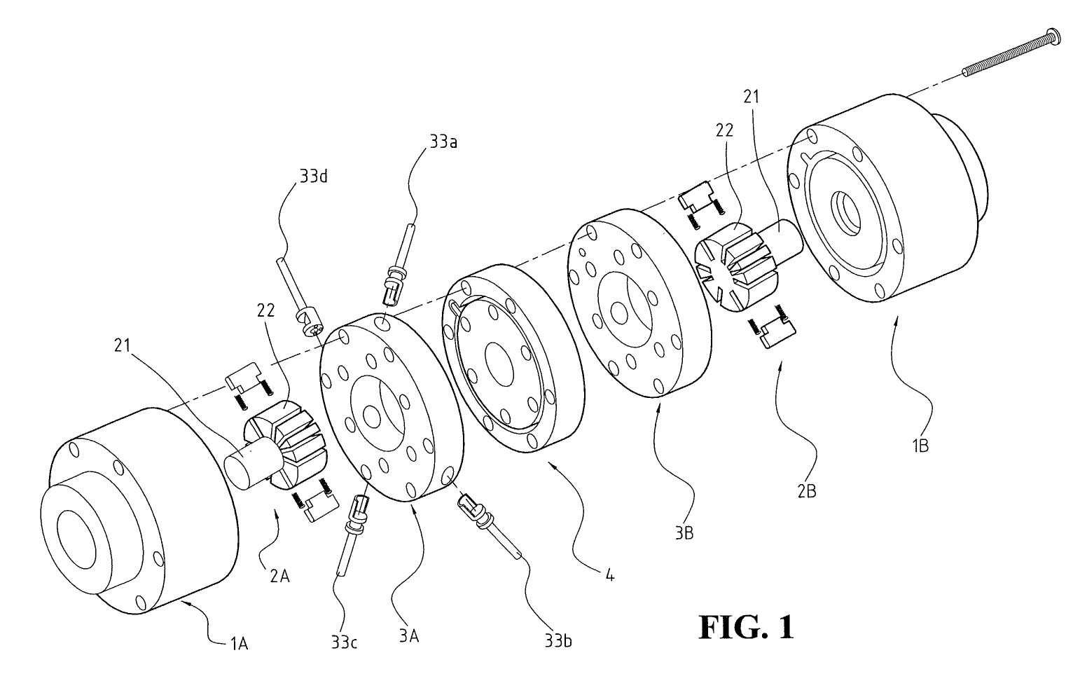

Referring to FIG. 1, the transmission device of the present invention comprises a front end member 1A and a rear end member 1B which is similar to the front end member 1A. An active rotor 2A and a passive rotor 2B which is similar to the active rotor 2A. An active device 3A and a passive device 3B which is similar to the active device 3A, and an intermediate member 4. The front end member 1A is connected to a shaft 21 on an end of the active rotor 2A and a radial plate portion 22 on the other end of the active rotor 2A is connected to the active device 3A. The rear end member 1B is connected to a shaft 21 on an end of the passive rotor 2B and a radial plate portion 22 on the other end of the passive rotor 2B is connected to the passive device 3B. Control valves 33a, 33b, 33c, 33d are connected to a periphery of the active device 3A at an equal angular interval. The front end member 1A, the active device 3A, the intermediate member 4, the passive device 3B and the rear end member 1B are connected with each other by bolts and a close space is defined in the assembly and filled with hydraulic liquid.

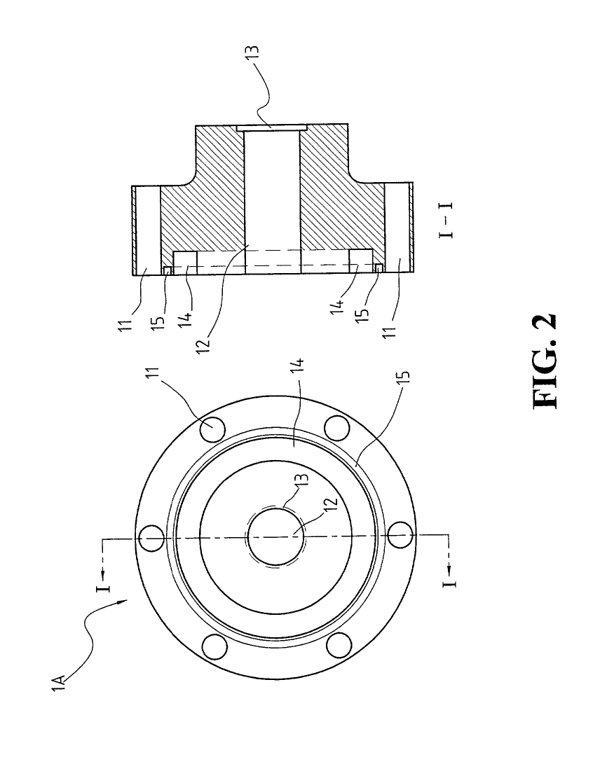

Referring to FIG. 2, the front end member 1A is a cylindrical member and has a plurality of holes 11 defined therethrough at an equal angular interval. The holes 11 are parallel with each other and a shaft hole 12 is defined centrally through the front end member 1A. An annular seal hole 13 is defined in a surface of the front end member 1A and its radius is larger than that of the shaft hole 12 so as to receive a seal therein.

An annular path 14 and an annular seal hole 15 are defined in the other surface of the front end member 1A and face the active device 3A. The inner diameter of the seal hole 15 is larger than the diameter of the path 14. A seal is received in the seal hole 15.

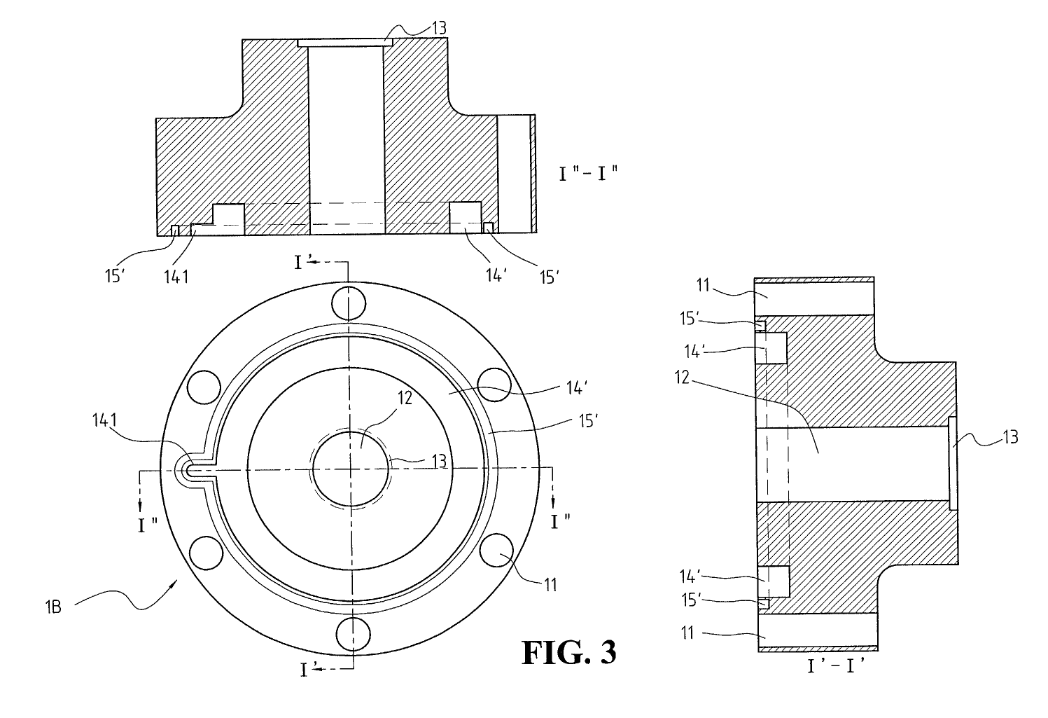

Referring to FIG. 3, the rear end member 1B is a cylindrical member and has a plurality of holes 11 defined therethrough at an equal angular interval. The holes 11 are parallel with each other and a shaft hole 12 is defined centrally through the rear end member 1B. An annular seal hole 13 is defined in a surface of the rear end member 1B and its radius is larger than that of the shaft hole 12 so as to receive a seal therein. An annular path 14′ and an annular seal hole 15′ are defined in the other surface of the rear end member 1B and face the passive device 3B. A recess 141 is defined in the seal path 14′. The inner diameter of the seal hole 15′ is larger than the diameter of the path 14′. A seal is received in the seal hole 15′.

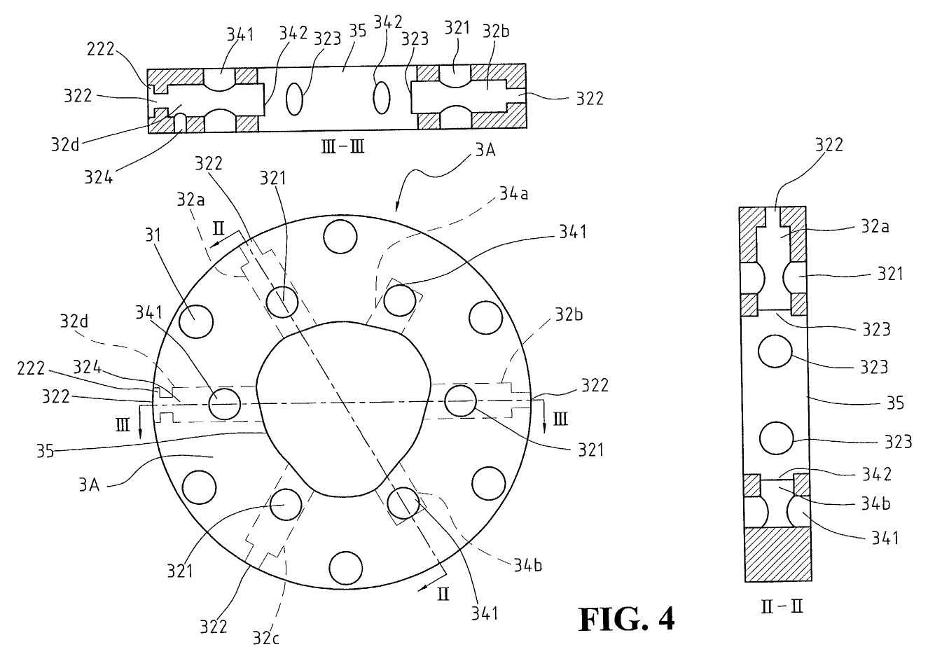

Referring to FIG. 4, the active device 3A is a cylindrical member and has a plurality of holes 31 defined therethrough at an equal angular interval, and the holes 31 are located in alignment with the holes 11 in the front end member 1A. The holes 31 are parallel with each other. A pressure chamber 35 is defined through a center of the active device 3A and a plurality of hollow guide slots 32a, 34a, 32b, 34b, 32c, 32d defined in radial direction. The guide slots 32a, 32b, 32c, 32d having an opening 322 defined through the active device 3A and the opening 322 of the guide slot 32d has a seal slot 222 which has an inner diameter that is larger than the opening 322 so as to receive a seal therein. The other end of the guide slots has an opening 323 communicating with the chamber 35. The guide slots 34a and 34b has an opening 342 communicating with the chamber 35, and the other end of the guide slots 34a, 34b is ended before the periphery of the active device 3A. The guide slots 32a, 34a, 32b, 34b, 32c, 32d each have a path 321, 341 that is defined through the active device 3A and perpendicular to the guide slots. The openings of these paths 321, 341 defined in the connection surface of the active device 3A and the front end member 1A are located in alignment with the annular path 14 in the front end member 1A. A recess 324 is defined in surface of the active device 3A that faces the intermediate member 4. The recess 324 communicates with the guide slot 32d and located in perpendicular to the guide slot 32d.

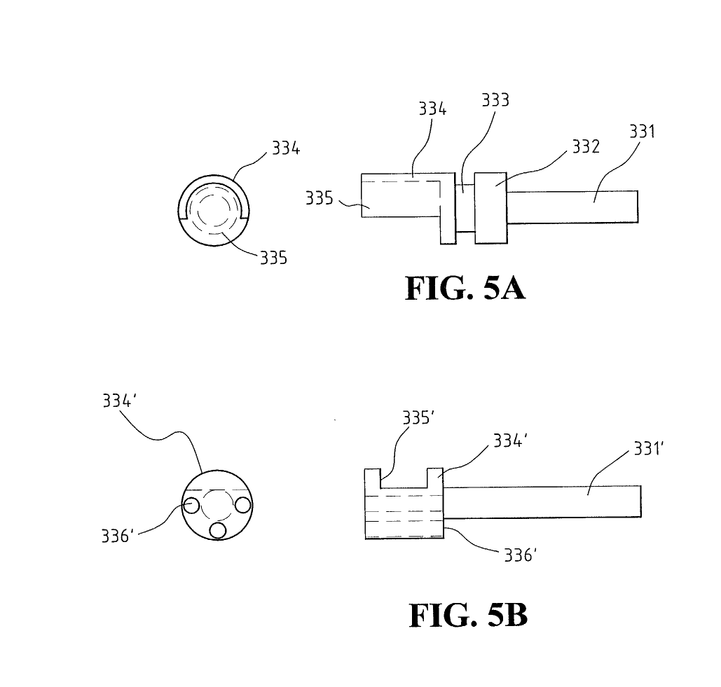

Referring to FIG. 5A, the control valves 33a, 33b, 33c each is composed of a rod portion 331, a stop portion 332, a neck portion 333, a guide plate 334 and a guide portion 335. A distal end of the rod portion 331 is connected to a device (not shown) that activates the control valves 33a, 33b, 33c. A seal is engaged with the neck portion 333. The guide plate 334 is a combination of a circular plate and a hollow cylinder wherein the hollow cylinder has a notch. The space between the hollow cylinder and the circular plate is the guide portion 335.

Referring 5B, the reverse-flow control valve 33d includes a rod portion 331′, a guide plate 334′, a guide portion 335′ and passing holes 336′. A distal end of the rod portion 331′ is connected to a device (not shown) that activates the reverse-flow control valve 33d. The guide plate 334′ that is connected to the other end of the rod portion 331′ is a solid cylinder which has a recess not exceeding over the central axis of the solid cylinder. A plurality of hollow members are defined in parallel with the central axis of the solid cylinder. The recess is the guide portion 335′ and the hollow members are the passing holes 336′ which do not communicate with the guide portion 335′.

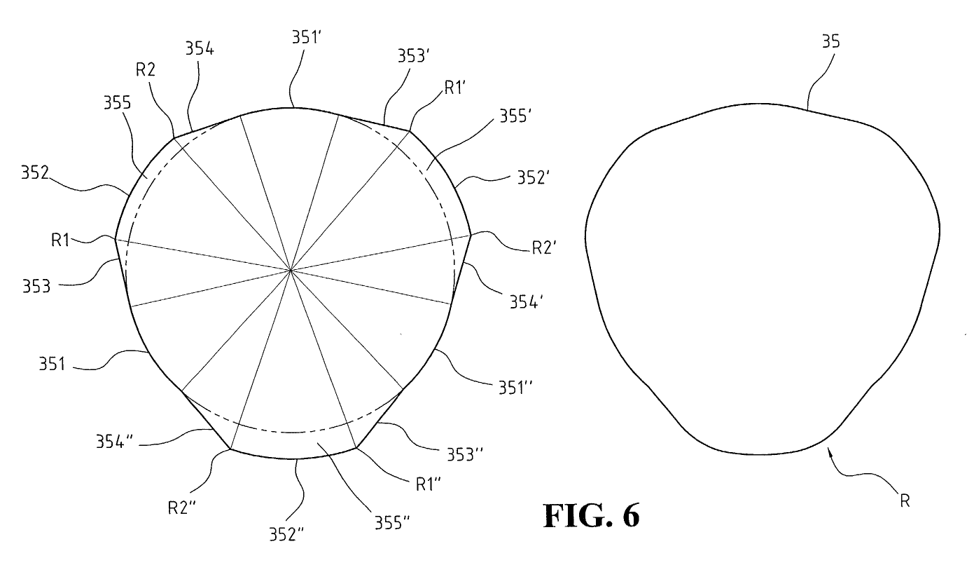

Referring to FIG. 6, the chamber 35 is a polygonal hole defined through the active 3A and each side of the polygonal hole has the same length. The polygonal hole is defined by a circle that is composed of several fan-shaped sections. The sections involve arcs 351, 351′, 351″ and some sections have extended radiuses so as to have arcs 352, 352′, 352″. One end of the arcs 351, 351′, 351″ is connected to the adjacent arcs 352, 352′, 352″ by a left line 353, 353′, 353″. The other end of the arcs 351, 351′, 351″ is connected to the adjacent arcs 352, 352′, 352″ by a right line 354, 354′, 354″. The left lines 353, 353′, 353″ are connected to the arcs 352, 352′, 352″ at angle R1, R1′, R1″. The right lines 354, 354′, 354″ are connected to the arcs 352, 352′, 352″ at angle R2, R2′, R2″. Therefore, the area 355, 355′, 355″ that are enclosed by the radius, the arcs and the angles has a certain ratio relationship.

The area ratio of the areas 355, 355′, 355″ can be 2:3:4.

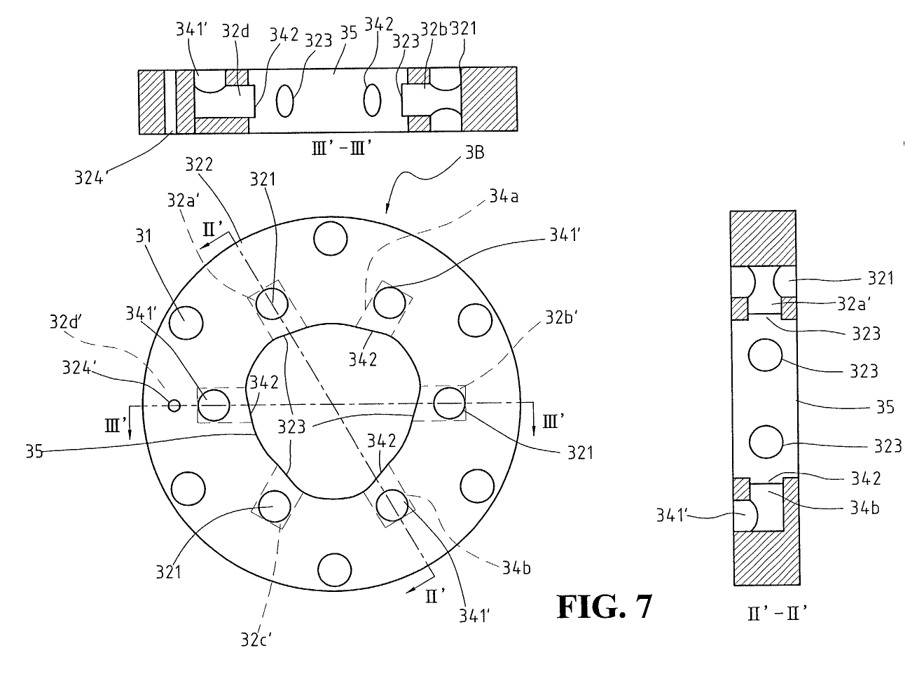

Referring to FIG. 7, the passive device 3B is a cylindrical member and has a plurality of holes 31 defined therethrough at an equal angular interval, and the holes 31 are located in alignment with the holes 11 in the rear end member 1B. The holes 31 are parallel with each other. A pressure chamber 35 is defined through a center of the passive device 3B and a plurality of hollow guide slots 32a′, 34a, 32b′, 34b, 32c′, 32d′ defined in radial direction. The guide slots 32a′, 32b′, 32c′ have an opening 323 which communicates with the chamber 35. The guide slots 34a′, 34b′, 32d′ have an opening 342 which communicates with the chamber 35. The guide slots 32a′, 32b′, 32c′ each have a path 321 that is defined through the passive device 3B and perpendicular to the guide slots. The opening of the path 321 defined in the connection surface of the passive device 3B and rear end member 1B is located in alignment with the annular path 14′ in the rear end member 1B.

The guide slots 34a, 34b, 32d′ have an opening 341′ which is located in perpendicular with the slots 34a, 34b, 32d′. The opening 341′ defined in the connection surface of the passive device 3B and the intermediate member 4. The opening 341′ has no opening defined in the passive device 3b and the rear end member 1B. Besides, the guide slots 32d′ has a recess 324′ which is located in perpendicular with the slot 32d and in alignment with the 141 defined in the seal path 14′ of the rear end member 1B.

The chamber 35 in the passive device 3B is the same as the chamber 35 in the active device 3A.

The path 321 and the opening 341′ of the slots 32d′ and 32a′, the path 321 and the opening 341′ of the slots 34a′ and 34b′, and the path 321 and the opening 341′ of the slots 34b and 32c′ are respectively located in the areas 355, 355′ and 355″.

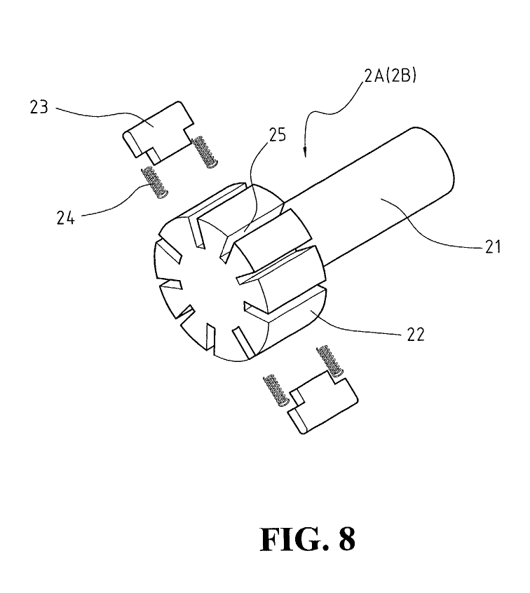

Referring to FIG. 8, the active rotor 2A has a shaft 21 which is engaged with the shaft hole 12 of the front end member 1A and connected to an input rotation power device (not shown). The radial plate portion 22 includes fan-shaped plates which are shaped to meet the shapes of the arcs 351, 351′, 351″ in the chamber 35 of the active device 3A. Gaps 25 are defined between the fan-shaped plates and each of the gaps 25 receives a T-shaped plate 23 which is engaged with two springs 24 so as to move radially along the inside of the chamber 35.

Referring to FIG. 8, the passive rotor 2B has a shaft 21 which is engaged with the shaft hole 12 of the rear end member 1B and connected to an input rotation power device (not shown). The radial plate portion 22 includes fan-shaped plates which are shaped to meet the shapes of the arcs 351, 351′, 351″ in the chamber 35 of the passive device 3B. Gaps 25 are defined between the fan-shaped plates and each of the gaps 25 receives a T-shaped plate 23 which is engaged with two springs 24 so as to move radially along the inside of the chamber 35.

A center angle between any two adjacent T-shaped plates 23 is smaller than the center angle of the areas 355, 355′, 355″.

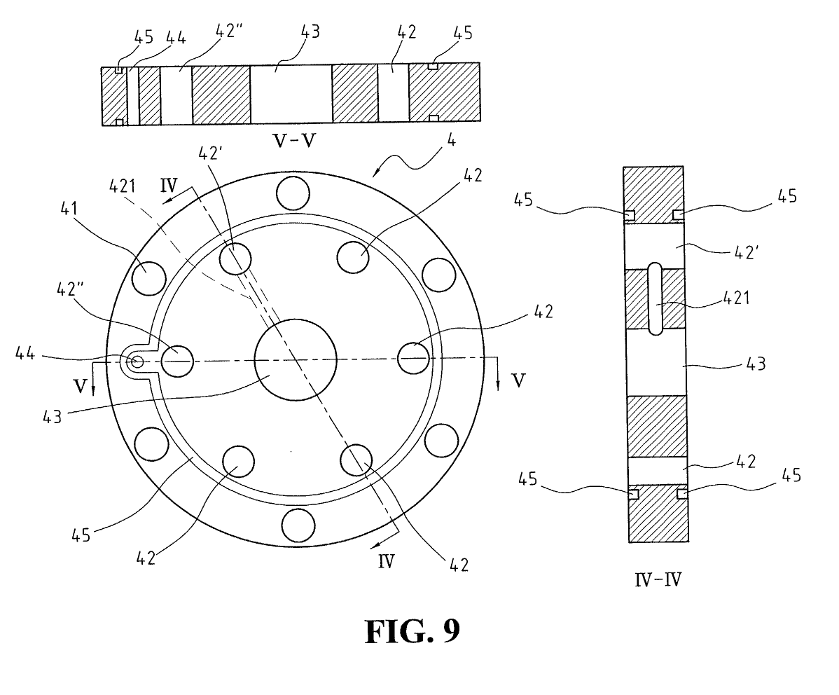

Referring to FIG. 9, the intermediate member 4 is a cylindrical member and has holes 41 defined in a surface thereof at an equal angular interval, and the holes 41 are located corresponding to the holes 31 of the active device 3A. The intermediate member 4 has oil holes 42′, 42, 42, 42, 42 and 42″ defined therethrough which are located corresponding to the paths 321, 341, 321, 341, 321, 341 of the active device 3A and the paths 321, 341′, 321, 341′, 321, 341′ of the passive device 3B. A sub-chamber 43 is defined through the intermediate member 4 and communicates with the oil hole 42′ via a tunnel 421. A recess 44 is defined in the intermediate member 4 and located close to the oil hole 42″. The recess 44 is located corresponding to the recess 324 in the active device 3A and the recess 324′ in the passive device 3B.

The inner periphery of the sub-chamber 43 is made to cooperate with the positions of the gaps 25 of the active rotor 2A and passive rotor 2B. The sub-chamber 43 does not communicate with the areas 355, 355′, 355″ of the active device 3A and passive device 3B. When the T-shaped plates 23 are moved along the inner side of the chamber 35, the hydraulic liquid between the gaps 25 and the T-shaped plates 23 can be released to or compensated from the sub-chamber 43 so as to prevent the situations of over-pressure or vacuum.

The intermediate member 4 has seal grooves 45 in the two surfaces that respectively face the active device 3A and passive device 3B. The grooves 45 enclose the oil holes 42′, 42, 42, 42, 42, 42″ and recess 44 and have seals received therein.

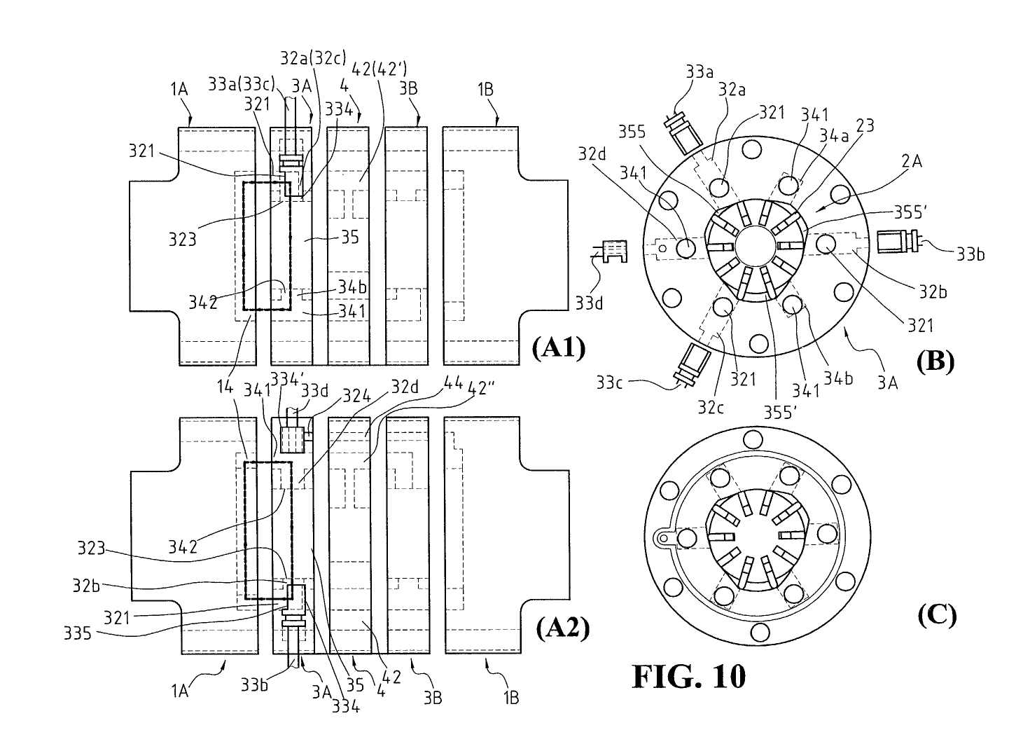

Referring to FIGS. 10(A1), 10(A2), 10(B), 10(C), when the control valves 33a, 33b, 33c are activated by activation device (not shown) and rotated in the guide slots 32a, 32b, 32c. The guide plates 334 rotate toward the openings of the paths 321 in the active device 3A and intermediate member 4. The guide portion 335 rotates toward the openings of the paths 31 in the front end member 1A and the active device 3A. The path 14 communicates with the paths 321 of the guide slots 32a, 32b, 32c. The paths 321 of the guide slots 32a, 32b, 32c do not communicate with the oil holes 42, 42′ in the intermediate member 4. When the reverse-flow control valve 33d is pulled to an outer extreme position in the slot 32d, the opening 341 of the slot 32d communicates with the path 14 of the front end member 1A and the oil hole 42″ in the intermediate member 4. The opening 341 of the slot 32d does not communicate with the recess 324 of the active device 3A. Therefore, when the active rotor 2A is rotated to move the T-shaped plates 23 to move from the slot 32d to slot 32a, or from the slot 34a to slot 32b, or from slot 34b to slot 32c, pressure differences are resulted on the hydraulic liquid by the movement of the T-shaped plates 23. The hydraulic liquid then flows from the areas 355, 355′, 355″ to the opening 323, slots 32a or 32b or 32c, 321 and then flows into the path 14, the slots 32d, 34a, 34b, and back to the areas 355, 355′, 355″. The circular path for the hydraulic liquid is shown by the thick dotted line in FIGS. 10(A1) and 10(A2).

In the situation mentioned above, no hydraulic liquid is sent to the passive device 3B so that the passive rotor 2B will not be affected by the hydraulic liquid to output power, and this is defined as idle status.

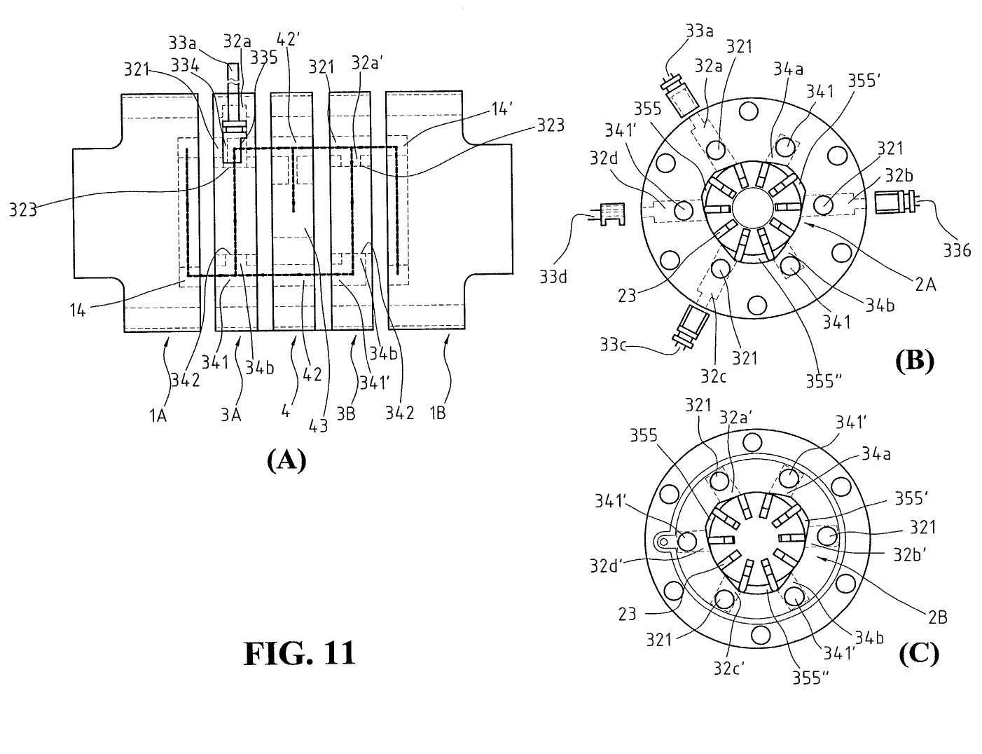

Referring to FIGS. 11(A), 11(B), 11(C), when the control valves 33b, 33c are activated to rotate in the slots 32b and 32c. The guide plates 334 are rotated toward the openings in the active device 3A and intermediate member 4, the guide portion 335 is rotated the openings of the paths 321 in the front end member 1A and the active device 3A. Therefore, the path 14 and the paths 321 of the slots 32b, 32c are in communication with each other. The paths 321 of the slots 32b, 32c do not communicate with the oil holes 42 in the intermediate member 4. When the reverse-flow control valve 33d is pulled to an outer extreme position in the slot 32d, the opening 341 of the slot 32d communicates with the path 14 of the front end member 1A and the oil hole 42″ in the intermediate member 4. The opening 341 of the slot 32d does not communicate with the recess 324 of the active device 3A. The control valve 33a is rotated in the slot 32a and the guide portion 335 is rotated toward the opening of the path 321 in the connection surfaces of the active device 3A and the intermediate member 4. The guide plates 334 are rotated toward the openings of the path 321 in the connection surfaces of the front end member 1A and the active device 3A. This makes the 14 and the slot 32a become closed, but the path 321 of the slot 32a communicates with the oil hole 42′ of the intermediate member 4. When the active rotor 2A is rotated to drive the T-shaped plates 23 to move from the slot 32d to slot 32a, or from the slot 34a to slot 32b, or from slot 34b to slot 32c, pressure differences are resulted on the hydraulic liquid by the movement of the T-shaped plates 23. The hydraulic liquid then flows from the areas 355, 355′, 355″ to the opening 323, slots 32a, 32b and 32c. The hydraulic liquid in the slots 32b and 32c will flow in the path 14 via the corresponding paths 321, and then flows in the slots 32d, 34a, 34b, and back to the areas 355, 355′, 355″. The hydraulic liquid entering in the slot 32a will flow in the slot 32a′ and the path 14′ in the rear end member 1B via the oil hole 42′ in the intermediate member 4 and the paths 321 of the passive device 3B, and then flow in the areas 355, 355′, 355″ of the passive device 3B via the openings 323 of the slots 32a′, 32b′, 32c′. The hydraulic liquid entering into the areas 355, 255′, 255″ of the passive device 3B drives the passive rotor 2B to drive the T-shaped plates 23 from slot 32a′ to slot 32d′, or from slot 32b′ to slot 34a′, or from slot 32c′ to slot 34b′ to make a circular movement. The pressure differences are resulted on the hydraulic liquid by the movement of the T-shaped plates 23. The hydraulic liquid then flows from the areas 355, 355′, 355″ to the opening 342, slots 32d′, 34a, 34b and then flows into the path 341, the oil holes 42′ or 42, and back to the path 341 in the active device 3A. The circular path for the hydraulic liquid is shown by the thick dotted line in FIGS. 11(A).

The volume of the hydraulic liquid that flows from the active device 3A to the passive device 3B is decided by the area 355 which is 2 of ninth volume of the total volume of the area 355, 355′, 355″. Therefore, the passive rotor 2B rotates 2/9 revolution when the active rotor 2A rotates a revolution. This is the first gear status of the transmission device.

When changing the control valves 33a and 33c to rotate in the slots 32a and 32c, and the guide plates 334 of the control valves 33a and 33c are rotated toward the opening of the path 321 in the connection surfaces of the active device 3A and the intermediate member 4, and the guide portion 335 is rotated toward the opening of the path 321 in the connection surfaces of the front end member 1A and the active device 3A. The control valve 33b is then rotated in the slot 32b and the guide portion 335 of the control valve 33b is rotated toward the opening of the path 321 in the connection surfaces of the active device 3A and the intermediate member 4. The guide plates 334 are rotated toward the opening of the path 321 in the connection surfaces of the front end member 1A and the active device 3A. The reverse-flow control valve 33d is maintained at the outer extreme position in the slot 32d. Because the volume of the area 355′ occupies 3/9 of the total volume of the areas 355, 355′, 355″, so that the active rotor 2A rotates one revolution, the passive rotor 2B rotates 3/9 revolution. This is the second gear status of the transmission device.

When changing the control valves 33a and 33b to rotate in the slots 32a and 32b, and the guide plates 334 of the control valves 33a and 33b are rotated toward the opening of the path 321 in the connection surfaces of the active device 3A and the intermediate member 4, and the guide portion 335 is rotated toward the opening of the path 321 in the connection surfaces of the front end member 1A and the active device 3A. The control valve 33c is then rotated in the slot 32c and the guide portion 335 of the control valve 33c is rotated toward the opening of the path 321 in the connection surfaces of the active device 3A and the intermediate member 4. The guide plates 334 are rotated toward the opening of the path 321 in the connection surfaces of the front end member 1A and the active device 3A. The reverse-flow control valve 33d is maintained at the outer extreme position in the slot 32d. Because the volume of the area 355″ occupies 4/9 of the total volume of the areas 355, 355′, 355″, so that the active rotor 2A rotates one revolution, the passive rotor 2B rotates 4/9 revolution. This is the third gear status of the transmission device.

When changing the positions of the control valves 33a, 33b and 33c in the first gear, second gear and third gear status to let the volume of the hydraulic liquid entering into the passive device 3B is the same as the volume of the area 355, 355′ or 355″. The volume of the hydraulic liquid entering into the passive device 3b from the active device 3A can be set to be the total volume of the area 355 and 355′, or the total volume of the area 355 and 355″, or the total volume of the area 355′ and 355″, or the total volume of the area 355, 355′ and 355″. When the active rotor 2A rotates one revolution, the passive rotor 2B will rotate respectively 5/9 revolution, 6/9 revolution, 7/9 revolution and one revolution. Their status are the fourth gear status, the fifth gear status, the sixth gear status, and the seventh gear status (full speed).

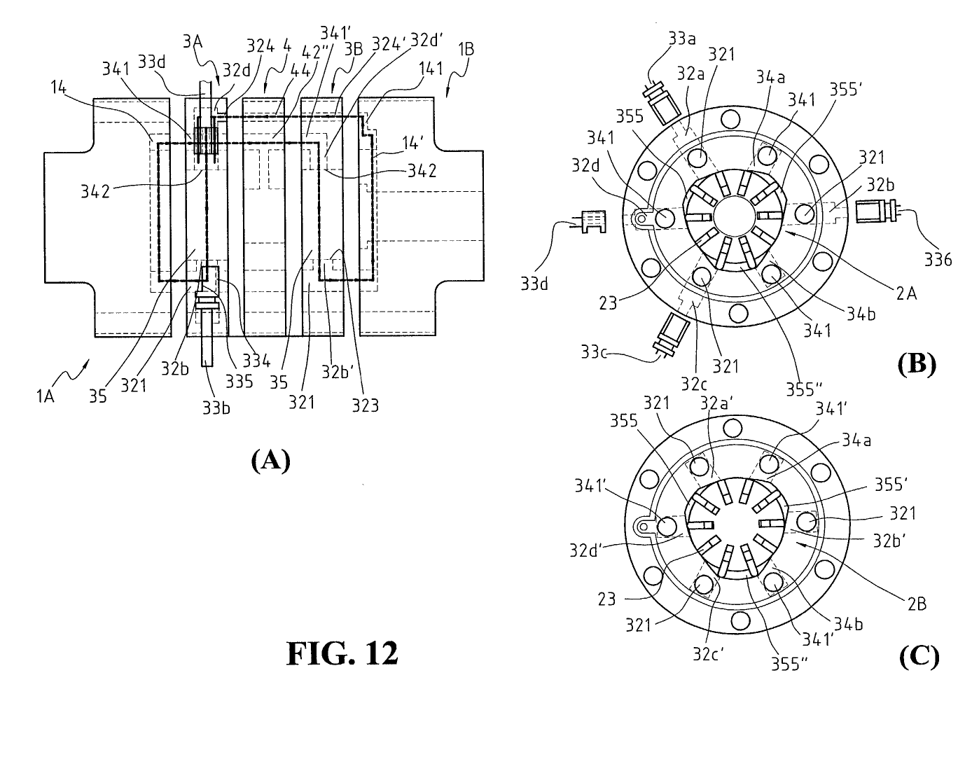

Referring to FIGS. 12(A), 12(B), 12(C), when the control valves 33a, 33b and 33c rotate in the slots 32a, 32b and 32c, and the guide plates 334 of the control valves 33a, 33b and 33c are rotated toward the opening of the path 321 in the connection surfaces of the active device 3A and the intermediate member 4, and the guide portion 335 is rotated toward the opening of the path 321 in the connection surfaces of the front end member 1A and the active device 3A. The path 14 communicates with the paths 321 of the slots 32a, 32b and 32c, but the paths 321 of the slots 32a, 32b, 32c do not communicate with the oil holes 42 and 42′ in the intermediate member 4. When the reverse-flow control valve 33d is moved radially to an inner extreme position in the slot 32d, the path 341 of the slot 32d communicates with the path 14 of the front end member 1A and the oil hole 42″ of the intermediate member 4 by the guide portion 335′ of the control valve 33d. The opening 342 in the slot 32d communicates with the recess 324 in the slot 32d via the passing hole 336′ and recess 324. The path 341 in the slot 32d does not communicate with the recess 324 in the active device 3A.

When the active rotor 2A is rotated to drive the T-shaped plates 23 to move radially from the slot 32d to slot 32a, or from the slot 34a to slot 32b, or from slot 34b to slot 32c, the pressure differences are resulted on the hydraulic liquid by the movement of the T-shaped plates 23. The hydraulic liquid then flows from the areas 355, 355′, 355″ to the opening 323, slots 32a, 32b and 32c. The hydraulic liquid in the slots 32a, 32b and 32c will flow in the path 14 via the corresponding paths 321, and then flows in the slots 32d, 34a, 34b. A part of the hydraulic liquid in the slots 34a and 34b will flow back to the areas 355′, 355″. The hydraulic liquid entering in the slot 32d will flow through the path 341 of the slot 32d, 34a, 34b of the active device 3A, the oil holes 42″, 42, the path 341 in the slots 32d′, 34a, 34b of the passive device 3B, and enters in the areas 355, 355′, 355″ via the opening 342 to drive the passive rotor 2B. The hydraulic liquid passing the guide portion 335 of the reverse-flow control valve 33d to make the T-shaped plates 23 move from the slot 32d to the slot 32a, or from the slot 34a to the slot 32b, or from the slot 34b to the slot 32c. The passive rotor 2b is rotated and hydraulic liquid in the areas 355, 355′, 355″ enters in the slots 32a′, 32b′, 32c′ via the opening 323, and then enters in the path 14′ of the rear end member 1B via the paths 321. The hydraulic liquid in the path 14′ will flow in the recess 324 in the active device 3A via the recess 324′ in the passive device 3B and the recess 44 in the intermediate member 4. The hydraulic liquid then flows into the area 355 in the active device 3A via the slot 32d, the passing holes 336′ in the reverse-flow control valve 33d, and the openings 342. By the route, a circular path of the hydraulic liquid is formed as shown in thick dotted line in FIG. 12(A).

In the above mentioned situation, the rotational direction of the passive rotor 2B is opposite to the rotational direction of the passive rotor 2B in the first to the seventh gear status. If the first to the seventh gear status of the latter one are defined as forward gears, the former one is defined as backward gears. The volume of the hydraulic liquid that are transferred to the passive device 3B from the active device 3A depends on the area 355 which is 2/9 of the total volume of the areas 355, 355′, 355″, so that when the active rotor 2A rotates one revolution, the passive rotor 2B rotates 2/9 revolution. The rotational direction of the passive rotor 2B is different from that in the first gear status, but their speed or dynamic power is the same.

While we have shown and described the embodiment in accordance with the present invention, it should be clear to those skilled in the art that further embodiments may be made without departing from the scope of the present invention.

What is claimed is:

1. A hydraulic transmission device comprising:
a front end member and a rear end member, each of said front end member and said rear end member having a shaft hole defined therethrough and an annular path defined in an end of each of said front end member and said rear end member;
an active device and a passive device each having a chamber and a plurality of holes defined therethrough, a plurality of hollow members guide slots defined through an active device and a passive device and being radially located around said chamber;
an active rotor and a passive rotor each having a shaft for being received in said shaft holes of said active device and said passive device, each of said active rotor and said passive rotor having a plurality of radial plates with gaps defined therebetween, said radial plates forming a plate portion and a plurality of plates movably received in said gaps;
an intermediate member having a sub-chamber defined therethrough and a plurality of oil holes defined through said intermediate member and located around said sub-chamber;
a recess defined in said annular path in said rear end member;
said chamber in each of said active device and said passive device being a polygonal hole with equal sides, said chamber being shaped to comprising a plurality of areas and a ratio relationship being existed between said volume of said areas, said plate portion of each of said active rotor and said passive rotor movably engaged with said chambers;
said guide slots each having a path that is defined through said active device and said passive device and is perpendicular to said respective guide slots, the number and positions of said paths defined in said active device, said passive device and said intermediate member being aligned with each other;
each of said areas in said active device having two guide slots communicating therewith and one of said two guide slots having an opening which communicates with a periphery of said active device, an opening communicating with the chamber and a control valve inserted in said opening, the other guide slot being s ended before the periphery of the active device, a reverse-flow control valve inserted in one of said two guide slots having the least volume;
said oil holes in said active device communicating with said annular path in said front end member, said guide slots that have control valves received therein, said oil holes in said passive device, and said annular path in said rear end member, and
a recess communicating with and located in perpendicular to said guide slot having said reverse-flow control valve, said recess having no communication with said annular path in said front end member, each of said intermediate member and said active device having a recess, said three recesses communicating with each other and communicating with said annular path in said rear end member via said recesses in said active device and said rear end member.

2. The device as claimed in claim 1, wherein said control valves each are composed of a rod portion and a guide plate connected to said rod portion, said guide plate comprising a circular plate and a hollow cylinder wherein the hollow cylinder has a notch, a space between said hollow cylinder and said circular plate being a guide portion.

3. The device as claimed in claim 1, wherein said reverse-flow control valve includes a rod portion and a solid cylinder connected to said rod portion, said solid cylinder having a recess not exceeding over a central axis of said solid cylinder, a plurality of hollow members defined in parallel with said central axis of said solid cylinder, said recess being a guide portion and said hollow members being passing holes which do not communicate with the guide portion.

4. The device as claimed in claim 1, wherein an closed space in said device is filled with hydraulic liquid.
